(19) United States
(12) Patent Application Publication
(10) Pub. No.: US 2005/0234932 A1
(43) Pub. Date: Oct. 20, 2005

(54) Method and apparatus for facilitating secure centralized administration of databases

(76) Inventors: Daniel M. Wong, Sacramento, CA (US); Min-Hank Ho, Newark, CA (US)

Correspondence Address: ORACLE INTERNATIONAL CORPORATION;c/o A. RICHARD PARK, 2820 FIFTH STREET, DAVIS, CA, 95616-2914, US

(21) Appl. No.: 10/822,242

(22) Filed: Apr. 8, 2004

(51) Int. Cl. G06F 7/00

(52) U.S. Cl. 707/100

(57) ABSTRACT

One embodiment of the present invention provides a system that facilitates configuring a database. During operation, the system requests database configuration information from a directory server that stores configuration information for a plurality of database instances. In response to this request, the system receives the database configuration information, and configures the database in accordance with the database configuration information received from the directory server. This enables the database server to be configured without requiring manual configuration operations by a database administrator.

### BACKGROUND

1. Field of the Invention

The present invention relates to databases. More specifically, the present invention relates to a method and an apparatus for facilitating secure, centralized administration of databases.

2. Related Art

As technology becomes increasingly more affordable, and as the number of applications that collect and maintain data increases, there has been a corresponding increase in the number of databases and database servers that organizations utilize to manage data. With the increased number of databases and database servers comes the added burden of administering these servers. For large-scale organizations that maintain hundreds of databases, this can prove to be a daunting task. Moreover, as employees come and go and security policies change, the databases and database servers can easily fall out of compliance with an organization's security policies, which can give rise to serious security vulnerabilities.

Enterprise organizations typically spend vast sums of money to ensure that all of their databases and database servers are up to date and are in compliance with an organization's policies. Traditionally, this involves employing a large number of database administrators who continually configure the databases and database servers to ensure compliance with the organization's policies. However, as the number of database administrators increases, so does the organization's potential vulnerability to a rogue administrator. Moreover, because database configuration operations are typically performed manually by administrators, the increased number of administrators results in an increased chance for human error.

Hence, what is needed is a method for configuring database servers without the problems listed above.

### SUMMARY

One embodiment of the present invention provides a system that facilitates configuring a database. During operation, the system requests database configuration information from a directory server that stores configuration information for a plurality of database instances. In response to this request, the system receives the database configuration information, and configures the database in accordance with the database configuration information received from the directory server. This enables the database server to be configured without requiring manual configuration operations by a database administrator.

In a variation on this embodiment, the database is structured as a database server, and the database configuration information includes service-related settings for the database server.

In a variation on this embodiment, the database configuration information can include an audit trail, a security model, a security protocol parameter, a maximum sessions parameter, a database block size, an optimization mode parameter, and an OLAP features parameter.

In a variation on this embodiment, the database configuration information can include an Access Control List (ACL). This ACL identifies objects and services which are available on the database server, and also specifies which hosts have permissions to use the objects and the services.

In a variation on this embodiment, the directory server is Highly Available (HA).

In a variation on this embodiment, the system caches a local copy of the configuration information to facilitate configuration of the database when the database cannot connect to the directory server.

In a variation on this embodiment, the system receives a request for resources from a user at the database and determines if the user is an enterprise user. If so, the system queries the directory server for a user profile associated with the user and subsequently receives the user profile from the directory server. The system then allocates resources to the user based on parameters specified in the user profile.

In a further variation, the user profile can include a CPU quota for the user, a disk quota for the user, a scheduling priority for the user, and a read/write/execute permission for the user.

In a variation on this embodiment, the database configuration information can define a Security Admin (SA) role for the database.

In a variation on this embodiment, the database server periodically queries the directory server for updated database configuration information for the database.

### BRIEF DESCRIPTION OF THE FIGURES

FIG. 1 illustrates a computing environment in accordance with an embodiment of the present invention.

FIG. 2 presents a flowchart illustrating the process of installing a database server in accordance with an embodiment of the present invention.

FIG. 3 presents a flowchart illustrating the process of granting access for resources to a user in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Environment

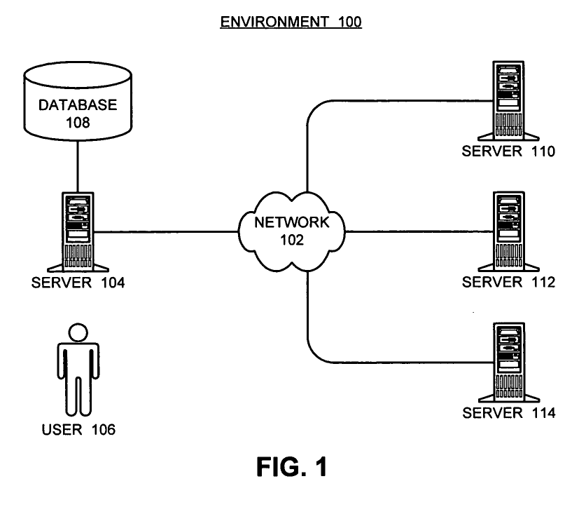

FIG. 1 illustrates computing environment 100 in accordance with an embodiment of the present invention. Computing environment 100 includes network 102. Network 102 can generally include any type of wire or wireless communication channel capable of coupling together computing nodes. This includes, but is not limited to, a local area network, a wide area network, or a combination of networks. In one embodiment of the present invention, network 102 includes the Internet.

Coupled to network 102 are servers 104 and 110 to 114. Servers 104 and 110 to 114 can generally include any nodes on a computer network including a mechanism for servicing requests from a client for computational and/or data storage resources. Coupled to server 104 is database 108. Database 108 can include any type of system for storing data in non-volatile storage. This includes, but is not limited to, systems based upon magnetic, optical, and magneto-optical storage devices, as well as storage devices based on flash memory and/or battery-backed up memory. Computing environment 100 also includes user 106 who interacts with server 104.

In one embodiment of the present invention, server 110 is a directory server that contains configuration information for database 108. This configuration information may include configuration information for the server 104 on which database 108 resides as well as configuration information for database 108. For example, directory server 110 may contain configuration information for database 108, including an audit trail, a security model, security protocol parameters, a maximum sessions parameter, a database block size, optimization mode parameters, and OLAP features parameters. This configuration information facilitates centralized management, unattended server and database installations, and user access to resources.

For example, as server 104 is installed, server 104 contacts directory server 110 via network 102 for configuration information pertaining to server 104 as well as configuration information for database 108 that is to be installed on server 104. This allows for server 104 and database 108 to be installed according to predefined policies with minimal or no input from user 106.

As users request resources on database 108, database 108 may query directory server 110 for access parameters for the requesting user. For example, as user 106 requests to gain access to resources controlled by database 108, database 108 may query server 110 for access information pertaining to user 106. This access information may include read/write/execute permissions for objects in database 108, a CPU quota for user 106, a disk quota for user 106, a scheduling priority for user 106, and a default profile for user 106.

Additionally, server 104 may keep a local cached copy of all configuration information received from directory server 110 to facilitate configuration and access control for times when directory server 110 may be unavailable.

Note that directory server 110 may be a standalone server, as well as a member of a cluster that includes servers 112 and 114. Aggregating configuration and security information for all databases and database servers within an organization at a directory server or a clustered directory server greatly reduces administration overhead as well as increases enterprise security. This allows for more servers to be configured, installed, and administered by fewer users which saves time and reduces potential security hazards.

Installing a Database Server

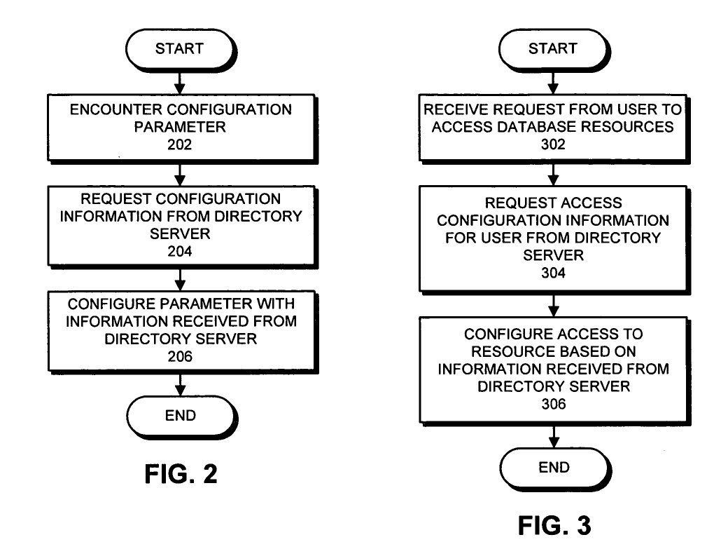

FIG. 2 presents a flowchart illustrating the process of installing database server 104 in accordance with an embodiment of the present invention. The system starts when database server 104 encounters a parameter to be configured for database server 104 (step 202). Next, database server 104 queries directory server 110 for configuration information for database server 104 (step 204). After receiving this configuration information, database server 104 configures the parameter with a value specified by the configuration information received from directory server 110 (step 206). Note that database server 104 may also cache a local copy of configuration information received from directory server 110.

Granting Access to Resources

FIG. 3 presents a flowchart illustrating the process of granting a user 106 access to resources in accordance with an embodiment of the present invention. The system starts when database 108 receives a request for resources from user 106 (step 302). In response to this request, database server 104 queries directory server 110 for all access configuration information pertaining to user 106 (step 304). Once the access configuration information is received, database 108 configures access permission for user 106 based on the received access configuration information (step 306). Note that user 106 may be a local user to database 108 who is unknown to directory server 110. In this case, database 108 may optionally access local configuration information not received from directory server 110. Note that additional variations and exceptions may be additionally defined through security policies on directory server 110.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for configuring a database, comprising:
requesting database configuration information from a directory server that stores configuration information for a plurality of database instances;
in response to the request, receiving the database configuration information from the directory server; and
automatically configuring the database with the database configuration information received from the directory server;
whereby the database server can be installed without manual configuration by a user.

2. The method of claim 1, wherein the database is structured as a database server, and wherein the database configuration information includes service-related settings for the database server.

3. The method of claim 1, wherein the database configuration option can include:
an audit trail;
a security model;
a security protocol parameter;
a maximum sessions parameter;
a database block size;
an optimization mode parameter; and
an OLAP features parameter.

4. The method of claim 1, wherein the configuration information can include an Access Control List (ACL), wherein the ACL lists objects and services available on the database server and which hosts have permissions to use the objects and the services.

5. The method of claim 1, wherein the directory server is Highly Available (HA).

6. The method of claim 1, further comprising caching a local copy of the configuration information to facilitate configuration of the database when the database cannot connect to the directory server.

7. The method of claim 1, further comprising:
receiving a request for resources at the database from a user;
determining if the user is an enterprise user;
if so, querying the directory server for a user profile associated with the user;
receiving the user profile from the directory server; and
allocating resources to the user based on parameters specified in the user profile.

8. The method of claim 7, wherein the user profile can include:
a CPU quota for the user;
a disk quota for the user;
a scheduling priority for the user; and
a read/write/execute permission for the user.

9. The method of claim 1, wherein the database configuration information can define a Security Admin (SA) role for the database.

10. The method of claim 1, wherein the database server periodically queries the directory server for updated database configuration information for the database.

11. A computer-readable storage medium storing instructions that when executed by a computer cause the computer to perform a method for configuring a database, the method comprising:
requesting database configuration information from a directory server that stores configuration information for a plurality of database instances;
in response to the request, receiving the database configuration information from the directory server; and
automatically configuring the database with the database configuration information received from the directory server;
whereby the database server can be installed without manual configuration by a user.

12. The computer-readable storage medium of claim 11, wherein the database is structured as a database server, and wherein the database configuration information includes service-related settings for the database server.

13. The computer-readable storage medium of claim 11, wherein the database configuration option can include:
an audit trail;
a security model;
a security protocol parameter;
a maximum sessions parameter;
a database block size;
an optimization mode parameter; and
an OLAP features parameter.

14. The computer-readable storage medium of claim 11, wherein the configuration information can include an Access Control List (ACL), wherein the ACL lists objects and services available on the database server and which hosts have permissions to use the objects and the services.

15. The computer-readable storage medium of claim 11, wherein the directory server is Highly Available (HA).

16. The computer-readable storage medium of claim 11, wherein the method further comprises caching a local copy of the configuration information to facilitate configuration of the database when the database cannot connect to the directory server.

17. The computer-readable storage medium of claim 11, wherein the method further comprises:
receiving a request for resources at the database from a user;
determining if the user is an enterprise user;
if so, querying the directory server for a user profile associated with the user;
receiving the user profile from the directory server; and
allocating resources to the user based on parameters specified in the user profile.

18. The computer-readable storage medium of claim 17, wherein the user profile can include:
a CPU quota for the user;
a disk quota for the user;
a scheduling priority for the user; and
a read/write/execute permission for the user.

19. The computer-readable storage medium of claim 11, wherein the database configuration information can define a Security Admin (SA) role for the database.

20. The computer-readable storage medium of claim 11, wherein the database server periodically queries the directory server for updated database configuration information for the database.

21. An apparatus for configuring a database, comprising:
a request mechanism configured to request database configuration information from a directory server that stores configuration information for a plurality of database instances;
a receiving mechanism configured to receive the database configuration information from the directory server in response to the request; and
a configuration mechanism configured to automatically configure the database with the database configuration information received from the directory server.

22. The apparatus of claim 21, wherein the database is structured as a database server, and wherein the database configuration information includes service-related settings for the database server.

23. The apparatus of claim 21, wherein the database configuration option can include:
an audit trail;
a security model;
a security protocol parameter;
a maximum sessions parameter;
a database block size;
an optimization mode parameter; and
an OLAP features parameter.

24. The apparatus of claim 21, wherein the configuration information can include an Access Control List (ACL), wherein the ACL lists objects and services available on the database server and which hosts have permissions to use the objects and the services.

25. The apparatus of claim 21, wherein the directory server is Highly Available (HA).

26. The apparatus of claim 21, further comprising a caching mechanism configured to cache a local copy of the configuration information to facilitate configuration of the database when the database cannot connect to the directory server.

27. The apparatus of claim 21, further comprising:
a second receiving mechanism configured to receive a request for resources at the database from a user;
a determination mechanism configured to determine if the user is an enterprise user;
a querying mechanism configured to query the directory server for a user profile associated with the user if the user is an enterprise user;
a profile mechanism configured to receive the user profile from the directory server; and
an allocation mechanism configured to allocate resources to the user based on parameters specified in the user profile.

28. The apparatus of claim 27, wherein the user profile can include:
a CPU quota for the user;
a disk quota for the user;
a scheduling priority for the user; and
a read/write/execute permission for the user.

29. The apparatus of claim 21, wherein the database configuration information can define a Security Admin (SA) role for the database.

30. The apparatus of claim 21, wherein the database server periodically queries the directory server for updated database configuration information for the database.
